(19) United States
(12) Patent Application Publication
(10) Pub. No.: US 2013/0175889 A1
(43) Pub. Date: Jul. 11, 2013

(54) DEVICE FOR GENERATING ELECTRICAL ENERGY FROM IRREGULAR MOVEMENT

(71) Applicant: Arne Hammer, Stuttgart (DE)

(72) Inventor: Arne Hammer, Stuttgart (DE)

(21) Appl. No.: 13/824,116

(22) PCT Filed: Sep. 16, 2011
(86) PCT No.: PCT/EP2011/066060

§ 371 Date: Mar. 15, 2013

(30) Foreign Application Priority Data
Sep. 17, 2010 (DE) 10 2010 037 626.4

(51) Int. Cl. H02K 7/18

(52) U.S. Cl. CPC H02K 7/1892
USPC 310/38

(57) ABSTRACT

The invention concerns a device for the generation of electrical energy from irregular motion which comprises a minimum of one generator which comprises a minimum of one impulse generator and a minimum of one induction unit and which is characterised in that the induction unit comprises a minimum of one coil element and a minimum of one magnetic element whereat the magnetic element/the magnetic elements are freely pivoted in relation to the coil element/the coil elements.

The invention is concerning a device for the generation of electrical energy. The invention is especially concerning a device which comprises at least one generator capable of converting mechanical energy from irregular movement into electrical energy.

Generators converting motional energy into electrical energy can be used in a wide variety of fields. One example would be the supply of electrical energy for portable consumer electronics and telecommunication devices. Alongside others, these devices comprise radios, mobile phones, navigation aids, mp3 players or gaming consoles etc. However, torches and lamps for camping could also be supplied by generators which convert kinetic energy into electrical energy. Furthermore, the accumulators (rechargeable batteries) powering these portable consumer electronics and telecommunication devices can be recharged by such generators. Even for non-portable devices which need to be supplied independently from an electrical network such generators converting kinetic energy into electrical energy represent an alternative of supply.

Prior art describes a range of generators able to convert kinetic energy into electrical energy.

By way of example, in WO 97/06592 A1 a device for the generation of electrical energy is described comprising a source of stored mechanical energy, a gear train connected to the source, a generator connected with the outlet of the gear train and a control circuit. This device has to store mechanical energy first before it can be converted into electrical energy as needed.

In WO 2005/031952 A1, a device for the generation of electrical energy is described at which jointly coupled magnets are guided through a tube-shaped coil generating an electrical voltage in this process. By reciprocating the jointly coupled magnets inside the tube-shaped coil alongside to a straight line a torch can be operated for example.

Also in WO 2009/126188 A2 an electromechanical system is described at which an electric voltage is generated by reciprocating magnets alongside a straight line past coils.

The published patent application EP 2 175 547 A2 discloses a combination of an oscillation device comprising an energy source, a wheel for example, and an oscillating mechanism arranged at it. A device for energy generation interacts with the oscillating device and a wire-wound coil to generate electricity by induction when the oscillating device swings. For this purpose two approximately semi-circularly bent bar magnets aligned in one plane and with the same poles towards each other are led through a likewise bent tube which is wrapped with a wire-wound coil.

The aforementioned systems are not very effective in converting irregular movement into electrical energy. Especially at movements which are not alongside the straight line at which the magnets are moving along no or hardly any electric voltage is generated.

With WO 2007/016781 A1 a device for the utilisation of mechanical energy and its transformation into electrical energy is disclosed which consists of a generator and limbs connected by a pivot joint. With this device, kinetic energy of an extremity rotating around a pivotal joint can be converted into electrical energy. The devices limbs are connected to a person such that the axis of rotation of its pivotal joint is aligned with the axis of rotation of the joint of the extremity at which the device is fastened to. Preferably the device is fastened to a leg at the height of the knee joint. Upon stretching the leg, mechanical energy is converted into electrical energy by the linear movement of the joint around its axis of rotation at which the energy of slow movement of the leg is transformed by mechanical aids into a fast rotation usable by the generator.

It could be considered as a disadvantage of a device as of WO 20071016781 that the device is rather unhandy and the wearer's freedom of movement would be at least hindered. Additionally, electrical energy is generated only by motions in a single direction but not at motions into the opposite direction. Furthermore, the device comprises complex mechanics at which a number of cogwheels interlock to transform the slow movement of the leg into a fast rotation usable for the generator.

Therefore, there is a demand for devices producing electrical energy from motion, especially using irregular motion.

The task is solved by a device according to claim 1. Preferred embodiments are subject of subclaims.

In one aspect the invention is concerning a device which generates electrical energy from the motion of a person, an animal or a plant for example swayed by the wind. In this aspect the invention comprises portable devices which can be attached to a person or an extremity of a person and which can transform the kinetic energy of natural motion of a person into electric energy.

In a different aspect the invention is concerning devices with which electric energy can be produced from preferably irregular motion of a lifeless object for example a buoy. In this aspect the invention comprises devices which are connectable to the object and which can transform the kinetic energy into electric energy.

The object of the device according to the present invention for the production of electrical energy from irregular motion is the idea to use inductivity for electricity generation. In this process, a voltage in an electric conductor is produced by the change of an external magnetic field penetrating the conductor. Such induced voltage in this conductor can be used to generate electricity. According to the present invention the device has at least one coil element and at least one magnetic element whereupon the coil element and the magnetic element are formed either in a discoidal, wheel shaped or spherical way. The coil element and the magnetic element are arranged to rotate freely so that the coil element and the magnetic element can rotate in respect to each other. In doing so the magnetic field in the conductor of the coil element changes and produces a voltage which can be transformed into electricity by a control circuit.

According to the present invention the device also has an impulse generator connected to the magnetic element or the coil element which generates a fastest possible rotational acceleration of the coil or magnetic element which is connected to the impulse generator even at slow motions of the device.

The device according to the present invention uses the principle of instability of a resting equilibrium to generate electrical energy. The impulse generator's resting equilibrium can be easily disturbed by motions, especially by irregular motions. The impulse generator transforms the irregular motion which the device performs being connected to a moving person, a moving animal, or a moving object into a rotational motion which is used to generate a voltage.

The rotational motion mediated by the impulse generator should take place essentially without friction. Thereby it is possible that pendulum motions or rotational motions of the impulse generator can build up even at small motions performed by the device. For example, the impulse generator can carry out rotational motions exceeding 360° when connected to a person's leg walking at constant pace. Even repeated rotations of 360° are possible. Furthermore, the pendulum motion or the rotational motion doesn't end abruptly if the device's isn't moved any more.

Additionally, a rotational motion of the impulse generator essentially without friction does not only allow full rotations but also a transition without delay from pendulum motion to full rotation and backwards, whereupon the device produces voltage independent of the rotational direction of the impulse generator and also independent of the impulse generator being in a uniform rotation or a pendulum motion (moving back and forth).

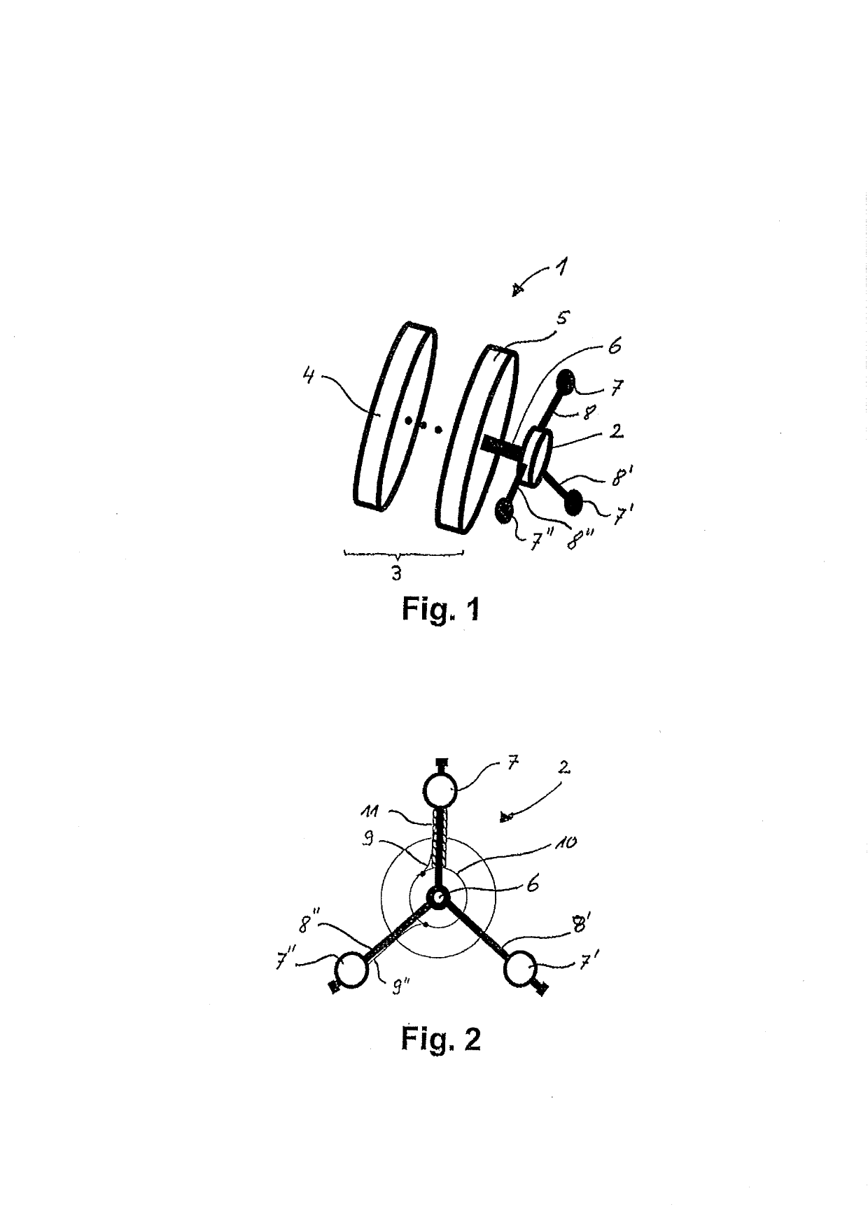

FIG. 1 is a schematic depiction of the essential elements of a generator for the generation of electrical energy from irregular motion using an embodiment of the device according to the present invention.

FIG. 2 is a schematic depiction of an exceptionally formed impulse generator.

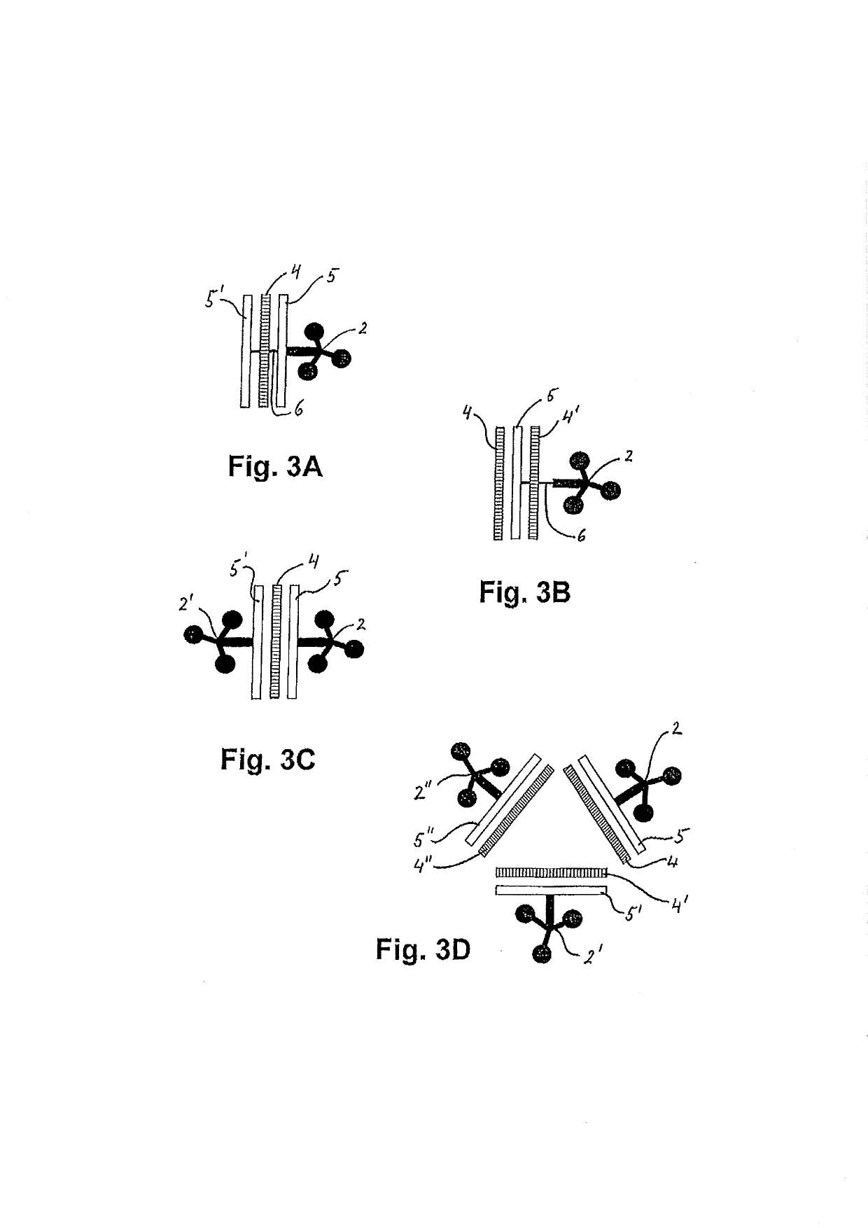

FIG. 3A to 3D demonstrate different arrangements of generators for the generation of electrical energy from irregular motion at different embodiments of the device according to the present invention.

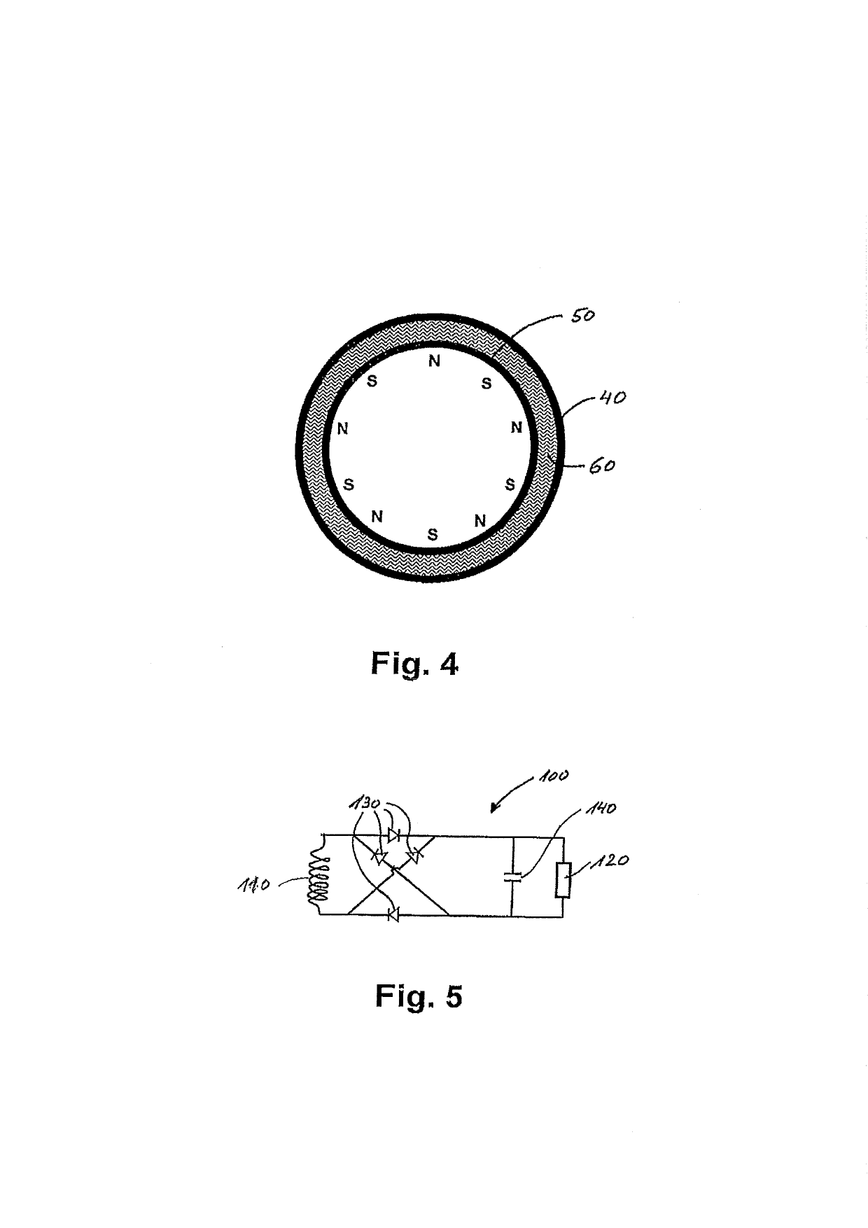

FIG. 4 demonstrates the essential elements of a generator for the production of electrical energy from irregular motion using another embodiment of the device according to the present invention.

FIG. 5 shows the circuit diagram of a control circuit for offtake of the voltage produced by the device according to the present invention.

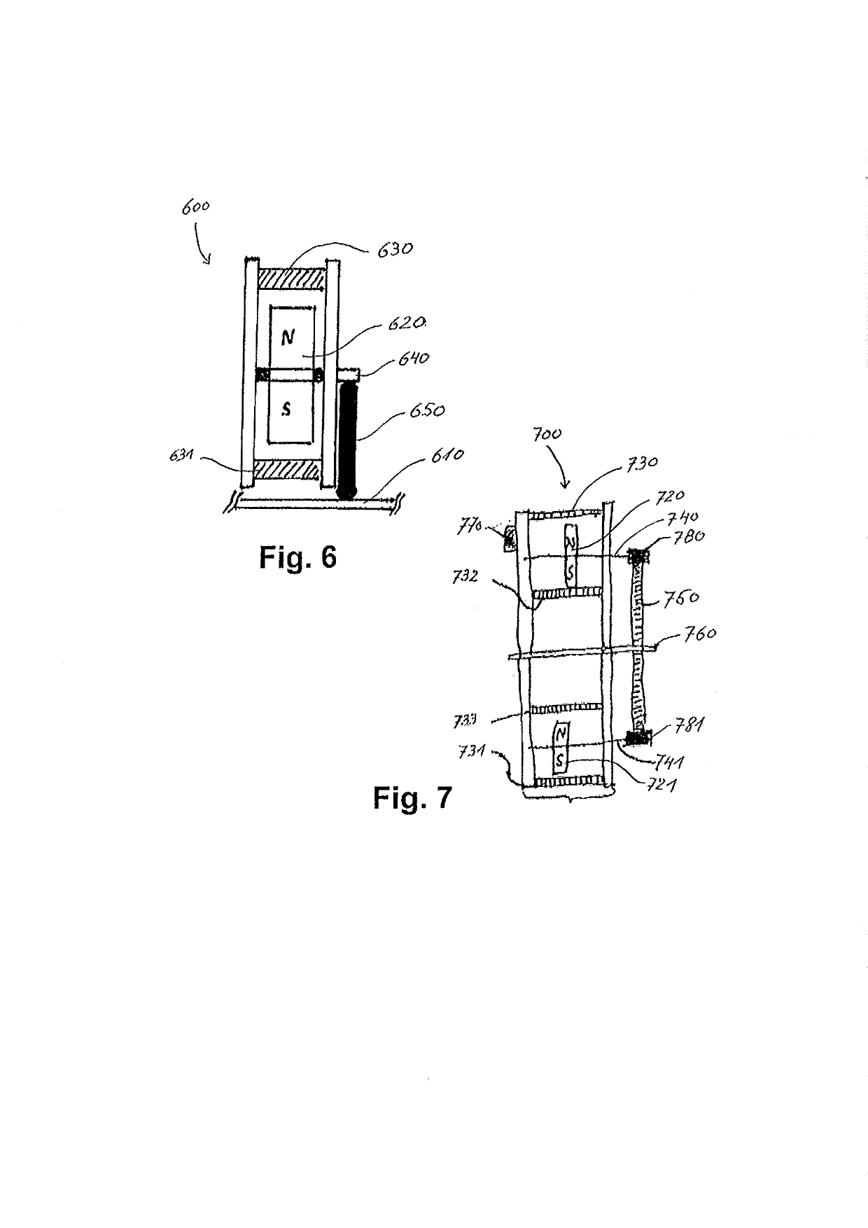

FIG. 6 shows an extract of an embodiment of the device at which a magnet of the induction unit is rotated by a drive wheel.

FIG. 7 shows an embodiment of the device at which the axis of the discoidal coil element is furnished with a drive disc which can rotate the drive wheels of the magnets of the induction unit.

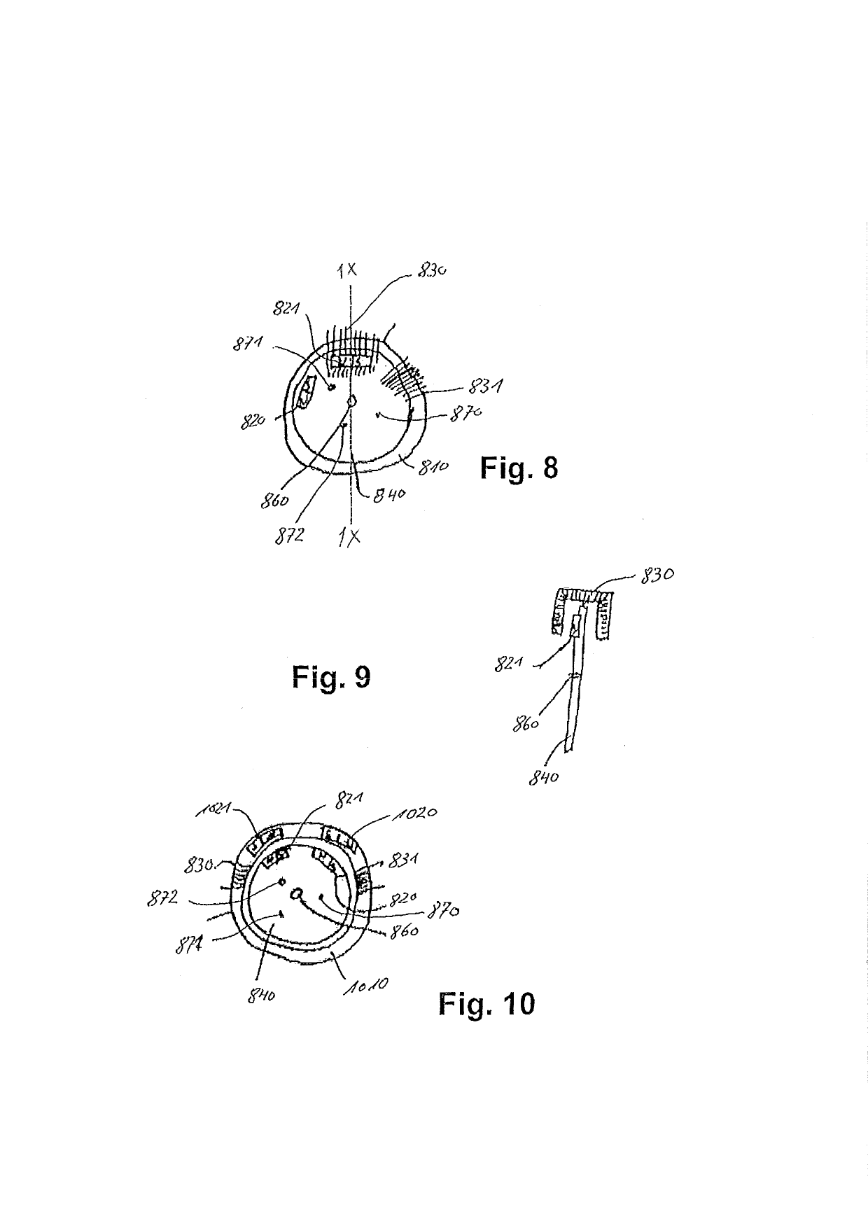

FIG. 8 demonstrates an embodiment with U-shaped coils.

FIG. 9 shows a cross section through the embodiment depicted in FIG. 8 alongside line A-A.

FIG. 10 is a schematic depiction of an embodiment at which a magnetic disc can drive magnets which run in a discoidal coil element and move through the coils.

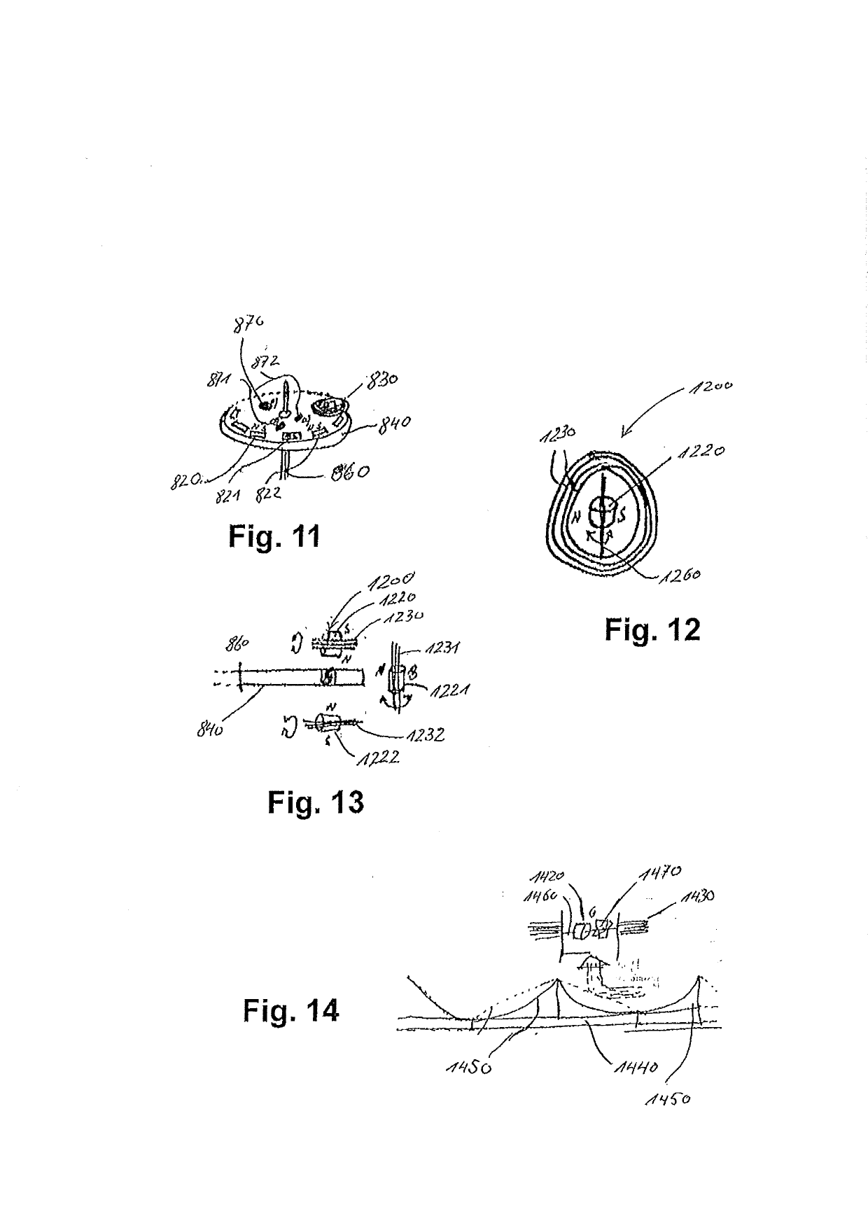

FIG. 11 demonstrates an embodiment with a coil laterally aligned to the magnetic disc with a rotatable magnet in the core area of the coil.

FIG. 12 depicts an embodiment of a coil according to the embodiment of FIG. 11.

FIG. 13 depicts possible arrangements of coils relative to the magnetic wheel at different embodiments according to embodiment of FIG. 11.

FIG. 14 shows a schematic cut through a disc with which an air stream can be produced which can set the magnets in rotation.

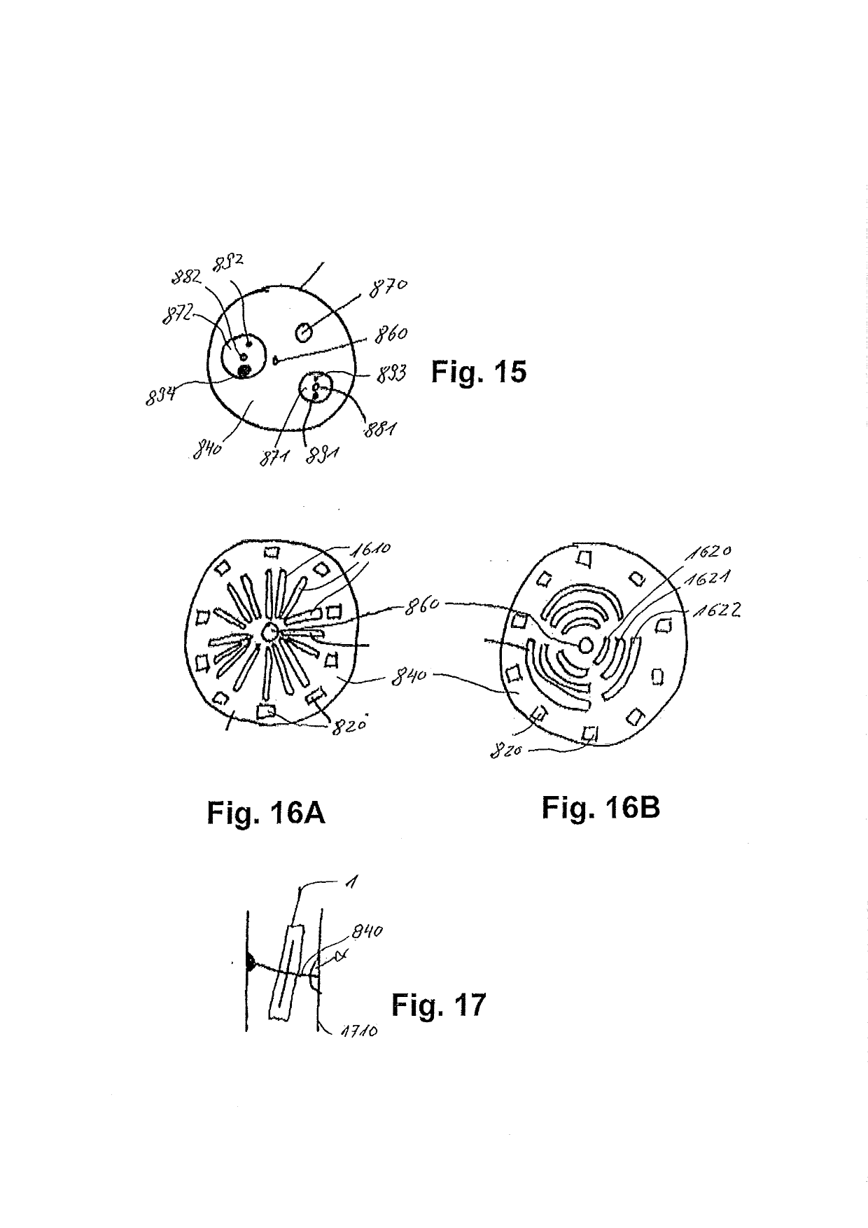

FIG. 15 shows an embodiment with a possible arrangement of weights at the magnetic disc.

FIGS. 16A and 16B show different embodiments of the magnetic disc regarding the arrangement of cut-outs for modifiable fixings of magnets at the magnetic disc.

FIG. 17 shows an embodiment at which the device, comprising parallel arranged magnet and coil elements, can fulfil precession motion in the device's housing.

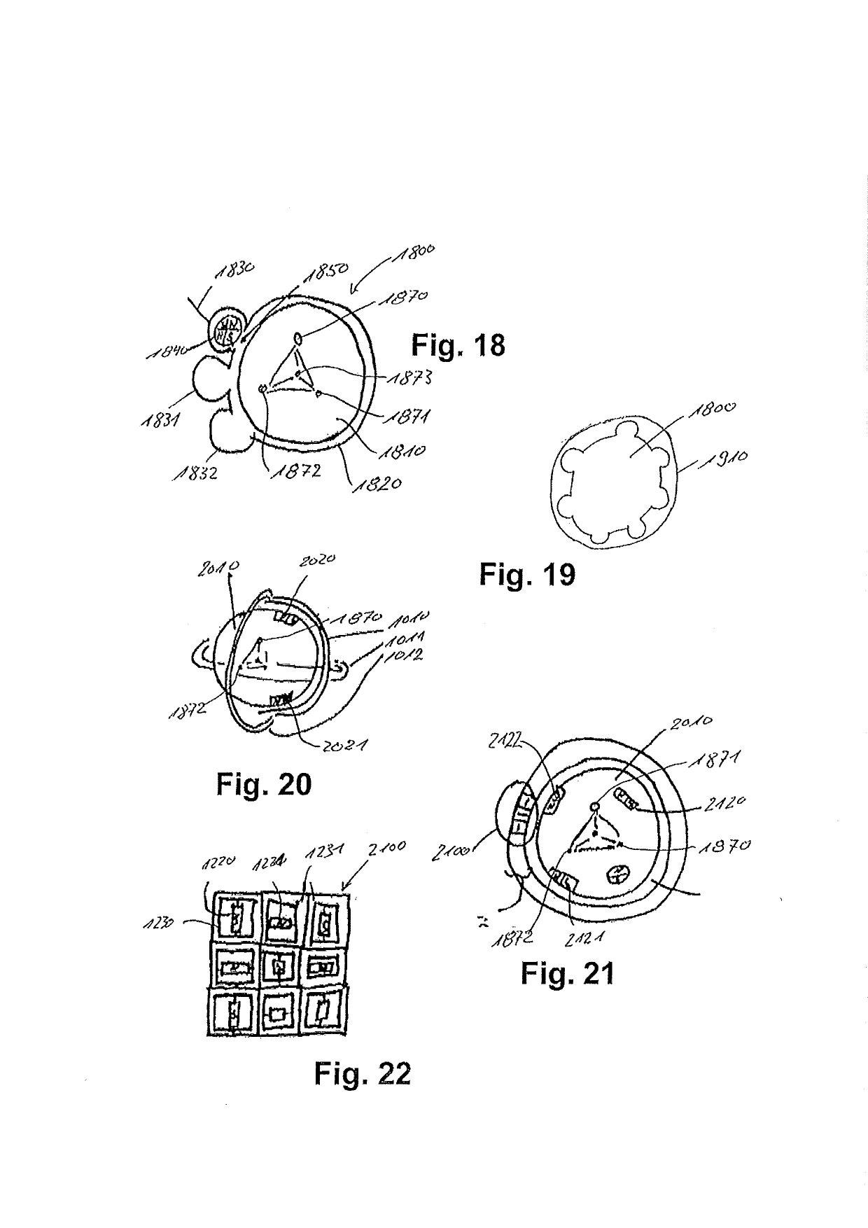

FIG. 18 shows a spherical embodiment of the device.

FIG. 19 shows a spherical embodiment of the device.

FIG. 20 shows a spherical embodiment of the device.

FIG. 21 demonstrates an embodiment of coil element and magnetic element at spherical embodiments.

FIG. 22 illustrates a possible arrangement of coils with magnets arranged rotatable in their core areas at an embodiment of the spherical device.

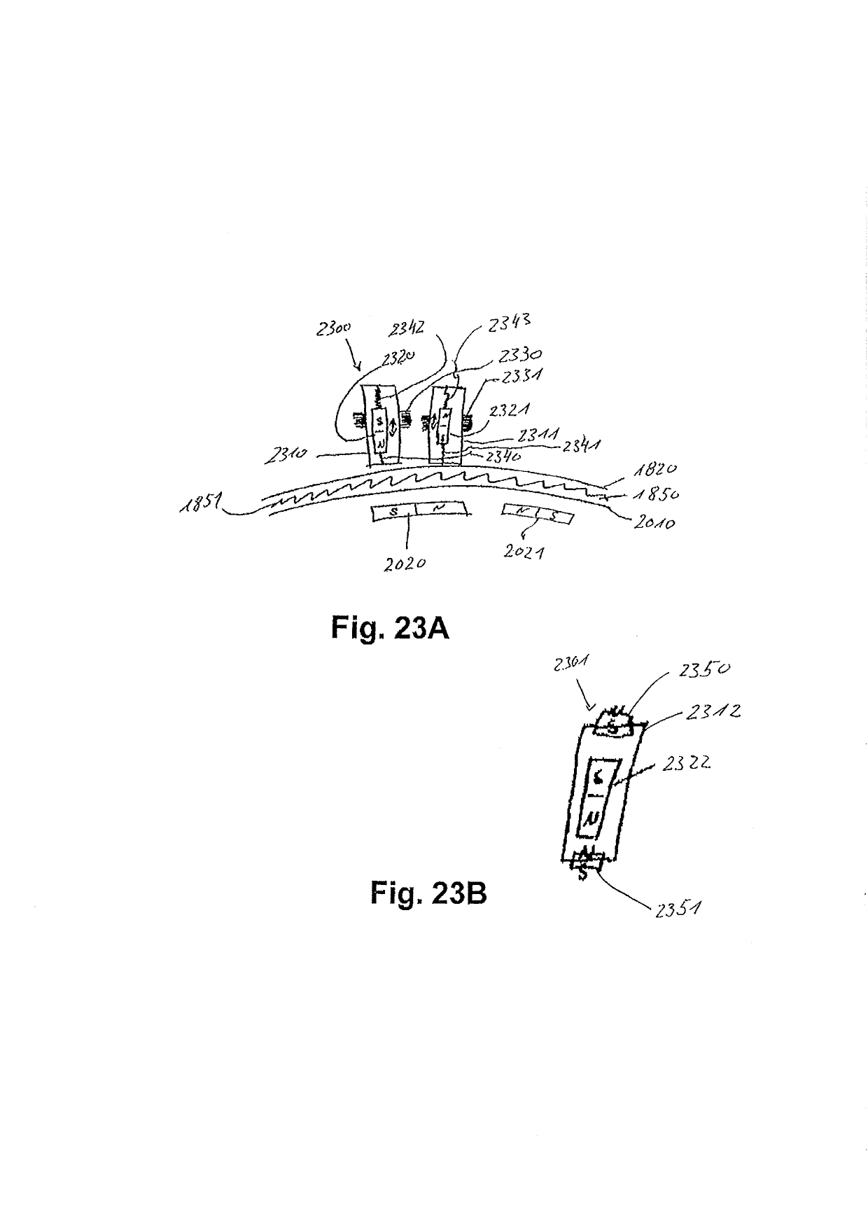

FIG. 23A shows an embodiment with magnetic coupling between the magnets of the impulse generator and the magnets in the coil's core areas which are mounted translationally movable via spring elements.

FIG. 23B shows an alternative embodiment for the usage of the magnetic coupling between the magnets of the impulse generator and the magnets in the coil's core areas which are held there translationally movable by magnets.

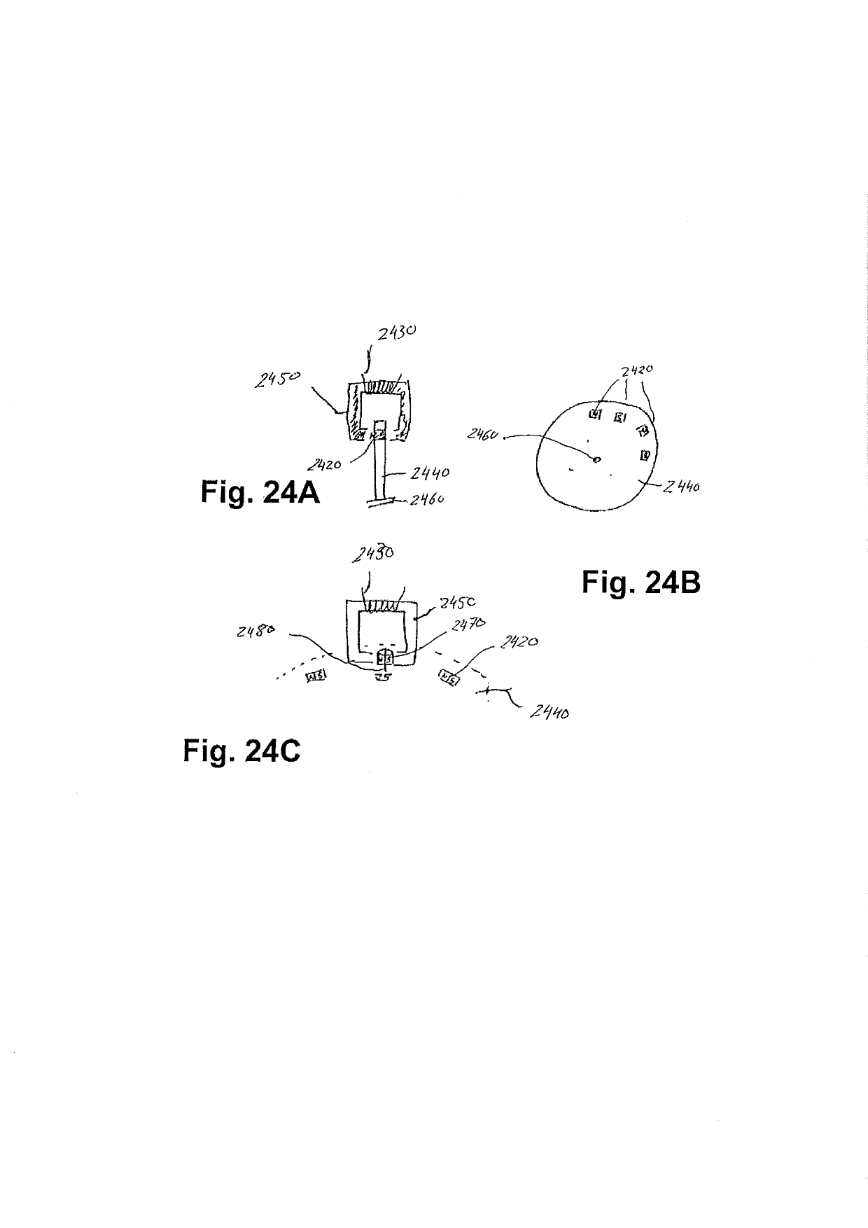

FIG. 24A shows a cross section of a possible embodiment for current collection.

FIG. 24B shows the disc depicted in FIG. 24A in top view.

FIG. 24C shows a different possible embodiment for current collection.

The device according to the present invention comprises an induction unit for the production of electrical energy and an impulse generator which transforms the irregular motion in rotation. The induction unit comprises at least one coil element and at least one magnetic element whereupon coil element(s) and magnetic element(s) are arranged pivotal in respect to each other.

In a first aspect of the invention the induction unit comprises at least one discoidal or wheel-shaped coil element and at least one discoidal or wheel-shaped magnetic element. In a basic embodiment of the device according to the present invention regarding the first aspect the induction unit comprises two discs alternatively wheels, a first disc and a second disc. The first disc acts as a coil. Thus it represents the coil element and is named turret as well. The turret is a disc which is wrapped with wire or arranged with wire slings at its surface especially at the side which is turned towards the second disc. In one embodiment at which the turret is a disc wrapped with wire the disc has an opening axial in its centre alternatively an axial hole and on one face of the disc the wire is led radially from the axial opening to the disc's border and on the opposite face back to the axial opening. As an electric conductor the wire can produce a voltage by changes of the magnetic field in the conductor.

The second disc concerns a disc which has multiple magnetic sectors or areas. Consequently, the second disc concerns the magnetic element which is also named magnetic disc for embodiments regarding the first aspect of the invention. The magnetic sectors or areas which the magnetic disc has have a magnetic positive pole and a magnetic negative pole at which the polarisation of adjacent sectors or areas at preferred embodiments is in the opposite direction. That means for example that that magnetic north pole of a sector is flanked by the magnetic south poles of adjacent sectors. It is also possible to arrange the magnetic areas on the magnetic disc such that the same poles of two adjacent areas are turned towards each other. In that way the magnetic field penetrating the electric conductor of the coil can be increased.

Within the induction unit of the device, the magnetic disc and the turret are arranged in a way that their faces are parallel to each other but spaced from each other. The centres of both discs are preferably arranged along a straight line perpendicularly to the face of both discs which also presents the axis of rotation of one of both discs, the pivoted disc. The space between the magnetic disc and the turret is as small as possible so that the magnetic field inside of the coil is as strong as possible. The magnetic disc and turret are arranged around the axis of rotation, which leads through the centres of the discs and is perpendicular to the faces of the discs, in a freely rotatable way with respect to each other so that the magnetic disc can change the magnetic field inside the conductor of the turret by its relative moment.

In a preferred embodiment the turret is firmly arranged in the device so it is not movable. At this embodiment the magnetic disc is pivoted so that the magnetic disc can rotate over the turret. In an especially preferred embodiment the turret is not only pivoted but integrated into the housing of the device in such a way that only the coils are arranged discoidally on the inside of the housing or are integrated into the housing. Nevertheless, the magnetic disc is arranged pivotable above the turret and can induce a voltage in the coil without a second wheel, a turret, being necessary. This embodiment enables a simple design for a control circuit because no component subject to possible wear is needed to connect the coil with further components of the control circuit. Generally, there are also embodiments possible at which the magnetic disc is firmly installed in the devices and the turret is pivoted.

The pivotally arranged disc of the induction unit is firmly connected with the impulse generator. Therefore, the impulse generator is pivotal as well. At another preferred embodiment the turret can also be firmly connected with the impulse generator. At these embodiments the magnetic disc is firmly arranged in the device. The disc firmly connected with the impulse generator is preferably connected to the impulse generator by a connecting axis so that the torque mediated by the impulse generator can be propagated by the connection axis to the disc firmly connected with the impulse generator.

The impulse generator is formed such that it experiences a rotational motion as high as possible even at small changes of the position of the device or at slight motions performed by the device. For this purpose, the impulse generator has an arrangement of at least one weight, preferably two or three weights. In terms of the invention, weight—alternatively weights which the impulse generator has—mean elements which possess a particular mass and connected with the axis which is connected with the pivoted disc. The weight or any of the weights can be a rod which is connected to the axis with one of its two ends. Provided the impulse generator has multiple rods as weights the rods cad differ from each other by their mass by different lengths and/or thicknesses and/or consist of different materials for example chosen from the group of materials comprising synthetic material, copper, iron, platinum and other metals.

The rods which the impulse generator has can also be cylinders filled with fluid. In this process, the single cylinders of an impulse generator can differ from each other regarding their length, their diameter, their wall thickness and/or their materials they consist of. Additionally, the different cylinders of an impulse generator can be filled with different quantities of fluid and/or different fluids which differ in their densities.

In a special embodiment the rod, several rods or any rod can be furnished with at least one additional weight. These weights are connected to the axis by the rods connected to them such that the resting equilibrium of the impulse generator is as instable as possible. This can be accomplished by the weights possessing different masses and/or are arranged differently spaced from the connecting axis so that the single weights of the impulse generator perform different torques to the axis. Consequently, the weights of the impulse generator allow a maximal rotational acceleration even at slight changes of position. However, the different weights of an impulse generator should not perform excessively different rotational torques to the axes because then the weights allow even a full rotation when for example the impulse generator completely rotates multiply around the connecting axis.

In an embodiment which comprises an impulse generator with two weights both of the weights are differently spaced from the axis of rotation and/or possess different masses, however considered separately they generate different torques in either case. In an embodiment with three weights at least two of the three weights possess different masses and/or are differently spaced from the axis of rotation, so that considered separately at least two of the three weights generate different torques in either case. Alternatively or additionally, the weights can be arranged in a way that their angle of connection to the axis of rotation is not 180° for two weights and not 120° for three weights. An embodiment with four weights, for example, can be arranged in the form of the Greek letter Psi, seen from top, at which the axis of rotation runs through the junction of the individual limbs.

The impulse generator transforms the irregular motion performed by the device in a rotation or pendulum motion which is propagated to the disc connected to the impulse generator.

In a special embodiment of the device any of the weights of the impulse generator is mounted movably on or at a separate rod. For this purpose, any of the weights can possess a bore hole through which one of the rods can stuck through. Any rod of the impulse generator is connected to the axis of rotation at one of its two ends. The single rods are pointing radially away from the axis. The angles between the rods can be equal or different. At the end not connected to the axis, any rod may have a barrier to avoid that a weight which is hoisted on the rod can be pulled off.

Between the axis of rotation of the impulse generator and any weight a scroll spring made of metal can be arranged which preferably encloses its respective rod and keeps the weight stuck on the rod at bay to the axis of rotation. Simultaneously, the single weights are connected by separate threads or wires to a roll functioning as a winch which is hoisted onto the axis of rotation. The roll can be operated by a rotating knob at which a blocking of the roll is possible so that it can move with the axis of rotation. By means of the roll functioning as winch, the weights can be placed along the rods and against the spring tension nearer to the axis of rotation or further apart. Thereby, the distance of the weights to the axis can be set individually and the rotational frequency of the impulse generator can be adjusted to/at different conditions of motion (going, running, jogging, and racing). The setting of the lengths of the thread is preferably carried out by a knob arranged externally of the impulse generator.

At another embodiment, springs can be used to set the spacing of the weights from the axis of rotation of the impulse generator. The springs are chosen that way that based on their condition (meaning their hardness and/or extensibility) an automatic setting of the weights is possible which are exposed to centrifugal and centripetal forces caused by the rotation. Thereby it can be prevented that the impulse generator, especially at embodiments at which by the magnets on the discoidal magnetic element the magnets of the induction unit respectively the coil element are moved by magnetic pulls, a maximum top speed at which the magnets of the induction unit respectively the coil element can be set in motion will not be exceeded. At excess of this maximum top speed the magnetic pull between the magnet of the magnetic element and a magnet of the induction unit would be cut off in consequence of inertia and the magnet of the induction unit would not be set in motion.

At another embodiment of an impulse generator with weights, their distance to the axis of rotation being adjustable the positioning of the weights along their rods can be carried out by means of a concentric wire. At this embodiment the weight is or the weights are mounted at a sling of wire or thread. Every sling extends movably along a rod from its distal end, therefore the end not connected to the axis at which the wire or thread is turned around, to the basis of the rod at which the wire or thread is turned around as well.

The guide roller at the basis of each rod is furnished with a mechanism for adjusting the wire's or thread's position along the rod. This mechanism can be considered as a cable pull. By operation of a mutual rotating knob or individual rotating knobs the weights mounted at the wire or thread can be pulled to the axis or from the axis by the wire or thread depending on the direction of rotation and in doing so be positioned along their rod and spaced from the axis.

In a special embodiment the impulse generator can be combined with the magnetic disc or the turret to a unit such that the weights are directly connected to the magnetic disc or turret. Fixing of the weights to the magnetic disc or the turret can be carried out for example by gluing, screwing, nailing, or welding. At this embodiment the impulse generator is not connected to the magnetic disc or the turret by an axis. At such embodiments the impulse generator and a part of the induction unit are the same component. Advantageously, at the arrangements of these embodiments, at which the impulse generator is combined to one unit with the magnetic disc, the weights can be magnets themselves, so additionally to the magnets as weights no additional weights or rods are needed. The weights of the embodiments, at which the impulse generator is directly combined to one unit with the magnetic disc or the turret, can also be fixed in an adjustable distance to the axis of rotation of the magnetic disc or the turret, at which they are fixed, as aforementioned presented for the impulse generator.

Preferably, the impulse unit is connected directly and firmly to the disc. However, at other embodiments of the device according to the present invention a gear drive can be inserted between the impulse generator and the induction unit. In this process the impulse generator is firmly connected with a cog wheel and the disc with another cog wheel, whereupon the cog wheels differ in diameter and tooth number. The gear drive can raise the device's performance/effectiveness by, for example, raising the rotational speed of the magnetic disc in relation to the rotational speed of the impulse generator.

In another embodiment the impulse unit and the pivotal disc of the induction unit can be connected by a v-belt or a chain. In this way, more compact devices can be realised which are advantageous especially for portable devices.

In a simple embodiment the device has a magnetic disc and a turret. In alternative embodiments the device can also have two turrets and a magnetic disc arranged between the turrets. It is also possible to furnish the device with two magnetic discs with a turret arranged in between. At a further embodiment the impulse generator has a cog wheel which is arranged on the axis of rotation. At this embodiment multiple induction units can be operated using a single impulse generator. Therefore any induction unit has a cog wheel which aligns with the magnetic disc and/or the turret and interacts frictionally engaged with the cog wheel of the impulse generator. Thereby the rotation or pendulum motion of the impulse generator can be transmitted by its cog wheel to the cog wheels of the induction units.

In other embodiments the magnetic pull is used to move the induction units. Here the so-called magnetic coupling is used. At a possible embodiment the impulse generator can comprise a circular disc, pivotable around its centre which has at or in the area of its outer edge a magnet or preferably multiple magnets or ferromagnetic metal bands. Likewise the induction unit has one or multiple magnets whereupon at least one magnet is contained in a ring-shaped closed tube with coils whose core consists of a section of the tube. The pivotal disc and the ring-shaped induction unit are preferably arranged in one plane at which the pivotal disc is axially arranged in the centre of the ring-shaped induction unit. The ring-shaped induction unit can also be arranged on top or below the plain of the pivotal disc in the area of the disc's magnets. At a rotation of the impulse generator the magnets or metal bands of the disc rotate on the inner face of the ring and pull the magnets contained in the ring-shaped tube with them in the tube due to the magnetic pull. If the magnets contained in the tube pass the section of the tube possessing a coil, an alternating voltage is produced.

At an alternative embodiment of the aforementioned embodiment the induction unit has a number of coils which are arranged alongside the periphery, ring-shaped around the magnet-possessing disc of the impulse generator. In this process any coil has an air core in which a magnet is arranged pivotally. The pivotally arranged magnet can concern a bar magnet or a spherical magnet pivotal around an axis, at which the polarisation is aligned perpendicularly to the axis of rotation which separates the magnet's north pole and south pole, or a freely pivotable spherical magnet. In any case, the magnet in the air core or the coil is arranged pivotally such that its magnetic field leaves and re-enters the coil at the magnet's rotation so that a change of magnetic field in the coil is accomplished when the magnet rotates and an alternating voltage can be produced by induction.

In a different embodiment the device has two impulse generators connected with each other at which any impulse generator has a magnetic disc and the two magnetic discs flank a single turret or two turrets arranged in parallel to each other. Preferably, both impulse generators are movable independently from each other. By arrangement of a second impulse generator with different weights a better utilization of different velocities can be achieved as the different impulse units have their maximum capacity at different motions. Both impulse generators can also be arranged on the same side but move independently from each other, for example by axes of rotation running interleaved.

In special embodiments the device can possess two magnetic discs being moved by one impulse generator. In another embodiment the device can possess two turrets flanking a magnet ring. In further embodiments the device can comprise an induction unit with multiple turrets at which the magnetic discs and the turrets are arranged alternating one after another along the axis or rotation. Such arrangements possessing two, three, four, five, six, or more combinations of magnetic disc and turret following one after another can be used particularly at larger objects, for example buoys, to produce electricity from their motion.

It is also possible to combine several separate generators in one device in order to optimally utilize different motion frequencies and directions of motion. For example, a device with three generators being arranged to each other in the form of a triangle is possible. This device can transform motion impulses from three directions into voltage. At a specially preferred embodiment the device has three generators arranged such that the axes of rotation of the three generators are standing perpendicularly to each other. Here the three axes of rotation correspond to the three spatial axes standing perpendicularly to each other. By this arrangement of the three generators, each comprising one induction unit and one impulse generator, all motions of the device in space can be used optimally for the production of electrical energy independently from their direction.

At a different embodiment the single magnets can be driven by a drive wheel, therefore being set in rotation, preferably in a rotation around an axis which separates the magnetic north pole from the magnetic south pole. At this embodiment any magnet of the device conduced to induction of voltage has an axis of rotation, which runs perpendicularly to the longitudinal axis of the magnet and leaves the discoidal coil element at one side. The discoidal coil element has an axis of rotation at which the driving wheel of rotation of the magnets is pivotally arranged between the axis of rotation of the discoidal coil element and the axis of rotation of the magnetic disc such that it propagates the rotation of the axis of rotation of the discoidal coil element to the axis of rotation of the magnets.

According to a special embodiment the axis of rotation of the discoidal coil element is furnished with a drive disc. Simultaneously, the axis of rotation of each magnet has a wheel. The drive wheel of the coil element and the wheel on the axis of rotation of the magnet are in contact to each other such that they touch each other at their peripheries at least in one point. So the rotation of the drive disc can be propagated to the wheel/wheels so that the magnets can be set in rotation when the discoidal coil element rotates. Alternatively, the drive disc and wheels can be cog wheels.

According to an embodiment the coil element can comprise one or several U-shaped coils. The U-shaped coil can be arranged at a larger disc. Magnets arranged on a smaller disc can be moved between the limbs of the U-shaped coil, for instance by rotating the smaller magnetic disc around an axis of rotation which aligns through the centres of the coil disc and magnetic disc congruently lying upon another.

U-shaped coils can be produced by initially winding wire spirally around a bearing, preferably with a circular cross section, afterwards removing the bearing out of the resulting spiral and then both ends of the elongated spiral are bent by about 90° at defined distances from their respective end at the same plane. Another method of U-shaped coil production consists in inserting a form with U-shaped cross section into the elongated spiral and pressing one side of the metal spiral into the form.

According to another or further embodiments the coil element is circular and has at least one coil and at least one magnet movable through the coil. This embodiment further has an impulse generator comprising a disc which at its periphery has multiple magnets in alternating succession/polarity or multiple ferromagnetic metal bands. At this embodiment the magnets movable through the coils are moved by the magnetic pull by the magnets arranged on the magnetic disc or the metal bands when the disc of the impulse generator is rotated around an axis of rotation aligning the centres of coil element and disc congruently lying on another.

According to an embodiment at least one of the weights is designed in the form of a chaotic pendulum, therefore in the form of a pendulum, whose motion is not predictable. An applicable chaotic pendulum has a first pendulum rod which is mounted in centre, in relation to its longitudinal axis, pivoted by 360° around a first pendulum axle. The first pendulum rod has a weight at one of its ends and at the other end a second pendulum rod pivoted by 360° around a second pendulum axle aligned parallel to the first pendulum axle. The second pendulum rod has a weight at one of its ends.

According to an embodiment the discoidal coil element and the discoidal magnetic element are aligned with their faces lying non-parallel to each other but twisted against each other by a defined angle. Therefore, the axis of rotation doesn't stand perpendicularly to the face of the discoidal coil element.

According to an embodiment the impulse generator can possess a disc with cut-outs which extend either spoke-shaped along an area of the disc's radiuses or in spherical segments with defined space to the centre of the disc. These cut-outs conduce to fasten or alignment of the weights. At a special embodiment of the embodiment with spoke-shaped cut-out springs for adjustment of the weights' distance to the axis of rotation of the impulse generator can be used. The springs are chosen so that depending on their condition (that means hardness and/or extensibility) they allow an automatic adjustment of the weights, which are exposed to centrifugal and centripetal forces by the rotation. Thereby it can be prevented that the impulse generator, especially at embodiments at which magnets of the induction unit respectively the coil element are moved by magnetic pulls by the magnets on the discoidal magnet element, doesn't exceed a maximum top speed at which the magnets of the induction unit respectively the coil element can still be set in motion. By exceeding the maximum top speed, the magnetic pull between a magnet of the magnetic element and a magnet of the induction unit would be interrupted and the magnet of the induction unit would not be set in motion.

According to an embodiment the device is designed such that it can perform a precession motion. Precession motion means the change of direction of an axis of a rotating object when outer forces execute a torque on it. At the embodiments with a discoidal magnetic element and discoidal coil element the discs are arranged parallel to each other so that their centres are aligned on an axis aligned perpendicularly to the faces of the discs. This alignment is installed in its housing such that the axis is connected movably to the inner surface of a housing wall only at one end so that the device precesses around this junction. Through this embodiment the irregular motion of the device can be better transformed into a rotation of the magnetic disc. At the precession motion the axis can move around its connection point with the housing wall.

The movable connection between the axis and housing wall which allows a precession motion of the device can be constructed by a sphere at the axis end which is arranged in an inversion of the housing's inner wall. Additionally, the axis is spring-loaded. Alternatively, the axis can possess a ring at its end at which it is movably connected to the housings inner wall, which is passed through a ring arranged at the housing's inner wall. These embodiments can possess a ring through whose opening the axis leads so that the axis' oscillation at its precession is limited and the axis' precession motion is quasi led. In any case, the device is mounted at the housing's inner wall such that a precession motion is transformed into an accelerated rotation.

Generally, it is also possible to attach the axis securely at a defined angle to the housing's wall.

An alternative embodiment with which velocity impulses from any direction can be utilized as effectively as possible is an embodiment of the generator as spherical generator at which the coil element and magnetic element are designed as spheres. Preferably, the magnetic element is arranged as a smaller sphere in the cavity of a larger sphere, which has wire windings for inductive electricity generation and therefore serves as a coil element. The spacing between the inner wall of the larger sphere and the outer wall of the smaller sphere shouldn't be larger than absolutely required so that the motion of the inner sphere is limited essentially to rotational motions and translational motions are essentially avoided. The spacing between the inner wall of the outer sphere and the outer wall of the inner sphere is determined such that the inner sphere is freely pivotable. The spacing between the inner wall of the outer sphere and the outer wall of the inner sphere is filled with a liquid in which the smaller sphere floats freely. Thereby, an essentially frictionless rotation of the inner sphere in any direction is enabled. This principle is known from spherical compasses for example. The optimal clearance of the spacing depends on the spherical generator's size and can be readily determined by a specialist.

The smaller sphere comprises at least one weight which can be arranged in the inside of the magnetic element designed as a hollow sphere. The weight can also be represented by at least one area of higher thickness or higher density of material which the wall of the magnetic element designed as a hollow sphere has. These weights make sure that the magnetic element always orients itself identically according to gravity. At the embodiments with spherical induction unit comprising a spherical coil element and a spherical magnetic element the weight of the magnetic element represents the impulse generator.

The term “spherical magnetic element” according to the present invention also means magnetic elements which are designed as a spherical segment, hemisphere, or spherical layer of a defined height. The term “spherical magnetic element” in addition comprises also embodiments with a spherical segment, a hemisphere, or a spherical layer and additionally possess one or several cuboids, cylinders, rings, discs or suchlike preferably arranged at the base area of the spherical segment, the hemisphere or the spherical layer.

As a liquid in the spacing between the outer wall of the inner sphere and the inner wall of the outer sphere miscellaneous liquids are to be considered. Applicable liquids react neither chemically nor physically with other materials of the generator. At usage of such liquids an impairment of correct operation of the generator is avoided. For example, care should be taken that the liquid is not a solvent for one of the materials it comes into contact with. The fluid should also be chosen not to react chemically with one of the materials it comes into contact with.

Applicable fluids are for example water, or a short-chained alcohol like methanol, ethanol, propanol or butanol. Further fluids which can be used are known to the specialist. Among these fluids are low-viscosity oils. In a special embodiment two fluids immiscible with each other can also be used. Preferably, the fluids have no influence on induction. The fluid can have an influence on induction.

The fluid in the space can be chosen so that the flotation of the inner sphere by the fluid and the mass of the inner sphere are balanced out against each other exactly. Thereby, the inner sphere is being held in a state of suspense so that an almost frictionless motion of the inner sphere is enabled. For example, a mixture of water and an alcohol can be used as a fluid at which the density of the water-alcohol mixture can be adjusted by the mixing ratio of water and alcohol.

In special embodiments the magnetic element inside the spherical coil element is not designed as a sphere but in the form of a ring or wheel or in the form of at least two interconnected rings or wheels. Preferably, the magnetic element designed in form of a ring or wheel floats or hovers horizontally arranged in the fluid. In a preferred embodiment the magnetic element is designed in the form of two interconnected rings or wheels at which both rings respectively wheels are arranged in an angle of 90° to each other. At this embodiment the two interconnected rings in each case represent meridians of an imaginary sphere including an angle of 90°.

In an especially preferred embodiment the magnetic element is not designed as a sphere but in the form of three rings or wheels standing perpendicularly to each other and being interconnected so that two of the three rings respectively wheels in each case represent meridians including an angle of 90° and the third ring respectively the third wheel the equatorial ring of an imaginary sphere.

In a special embodiment the inner sphere is furnished with appendages over which it can be moved itself by the fluid. Accordingly, this applies to the outer sphere. However, the free rotatability of the spheres to each other must be ensured.

Instead of appendages it can be worked with notches which lead to a frictionless gliding or floating of the spheres in each other. Motions of the spheres among each other or the motion of the fluid to one or both spheres can be transmitted by the notches.

According to an embodiment the spherical device has an outer shell which has several small magnetic spheres in single compartments at which the single compartments are in touch with the lumen of the shell so that a fluid being in between the inner magnetic sphere and the shell can set the small magnetic sphere in the compartments in rotation by its stream.

According to another embodiment the outer shell of the spherical impulse generator can also be enclosed by several smaller hollow spheres with each of them containing a spherical magnet whereupon any spherical magnet is contained freely pivotable in the inside of a small hollow sphere. The cavity of the impulse generator enclosed by the outer shell and the cavities of the smaller hollow spheres enclosing the outer shell are not connected with each other, but are separate self-contained compartments. Each of the small hollow spheres with a spherical magnet represents a coil element because each of the small hollow spheres has a coil. The sphere of the impulse generator contained in the cavity enclosed by the outer shell has magnets at its surface which upon the rotation of the sphere are passed by at the inner face of the outer shell of those areas at which the small hollow spheres are arranged. By the magnetic pull between the magnets of the impulse generator and the spherical magnets in the inside of the small hollow spheres the spherical magnets can be set in rotation if a magnet of the impulse generator is passed by the area of the small hollow sphere.

In a different embodiment the magnets movably arranged in the coil's core areas can be arranged such that they can fulfil a translational motion in the core area. For this purpose, the magnets can be connected to a holding device by spring elements which connect the poles of the magnets to the holding device which are enclosed by a coil being arranged perpendicularly to the magnet's longitudinal extension respectively parallel to the plane separating the two poles of the magnet. As spring elements, spiral springs, rubber bands or other flexible components can be used. Alternatively to this, the magnet can be held movable in the holding device by further magnets which are arranged at the opposite ends of the holding device and are oriented with those poles towards the movably arranged magnet with the same polarity as the pole of the movable magnet directed to the respective holding magnet.

The devices especially well-suited for the utilisation of motions of any direction are preferably used for the generation of electrical power by wave motion, for example buoys.

The alternating voltage produced in the conductor by the induction unit is rectified by an electronic component so that the electricity flows only in one direction independent of the direction of motion producing voltage. Such components possess a rectifying circuit also known as Graetz circuit.

The device according to the present invention can be used for the generation of electric current from motion, especially from irregular motion.

There is also the possibility of reversing the process by appropriate arrangement of magnets and induction windings and to operate the device by power entry as a motor, for example as a pump.

The present invention extends also to the utilisation of the device according to the present invention for the generation of electrical energy from motion energy.

The invention is described below in more detail with regard to the figures. In this process is has to considered that the figures only have a demonstrating relevance and don't constrict the invention in no way. The statement of numbers and/or arrangements does not constrict the invention to these statements. There can exist more as well as less of the following stated components and/or they may be arranged differently as depicted.

FIG. 1 shows the essential components of an embodiment of a generator for the generation of electrical energy from irregular motion according to the present invention. The generator 1 comprises an impulse generator 2 and an induction unit 3 comprising a turret 4 and a magnetic disc 5. The magnetic disc 5 is connected to the impulse generator 2 by an axis 6. The impulse generator 2 has three weights 7, 7′ and 7″ which are in each case connected to axis 6 by a short rod 8, 8′ and 8″.

At a motion of the generator the impulse generator 2 is set in rotation so that the magnetic disc possessing magnetic sectors or areas rotates. Thereby, the magnetic field in the conductor (not displayed) changes whom the turret has and a voltage is induced in the conductor.

FIG. 2 demonstrates the essential elements of another embodiment of the device according to the present invention. The impulse generator 2 has three rods 8, 8′ and 8″ connected to the axis 6. On each of the three rods a weight 7, 7′, and 7″ is movably arranged such that at a rotation around axis 6 each weight is movable to the outer ends of the rods 8, 8′ and 8″ according to the centrifugal force. The weights 7, 7′ and 7″ are connected by a threat or a wire 9 and 9″ (not shown for weight 7′) to roll 10 which is pivoted on axis 6 and on which the threats or wires can be wound up independent of a rotation of axis 6. By winding up the wires or threats, the weights 7, 7′ and 7″ can be positioned closer to axis 6 along their rods 8, 8 and 8″ so that the spacing of the weights to axis 6 is adjustable. The threats or wires counteract the centrifugal force the weights 7, 7′ and 7″ are exposed to at the rotation of the impulse generator around axis 6 and thereby preventing an unintentional outward slipping of the weights following the centrifugal force at the rotation. A scroll spring 11 (not shown for weights 7′ and 7″) arranged between axis 6 and weight 7 keeps weight 7 at bay to axis 6 even in idle state. Through the positioning of the weights by winding the threats or wires the spacing to axis 6 can be adjusted so that the torque exerted by the single weights can be adapted to the intensity of the irregular motion. The drag force of the threats and the springiness of the springs act opposing and ensure a precise positioning of the weights on the rods.

FIGS. 3A and 3D show different embodiments. According to FIG. 3A the generator can comprise a turret aligned between two magnetic discs 5 and 5′. At this embodiment both magnetic discs 5 and 5′ are connected with each other by an axis 6 which goes through a bore hole in the turret.

In a different embodiment as depicted in FIG. 3B the generator can comprise two turrets 4 and 4 between which the magnetic disc 5 is positioned.

At the embodiment according to FIG. 3C the generator has two impulse generators 2, 2′ which are each connected to a magnetic disc 5, 5′. The impulse generators 2, 2′ are arranged with their magnetic discs 5, 5′ on opposite sides of a turret 4.

In the embodiment according to FIG. 3D the device has three generators which are arranged to each other such that the discoidal induction units are forming an equilateral triangle.

FIG. 4 is a schematic drawing of a cross section through an embodiment of the generator with a spherical coil and a magnetic element. The magnetic element 50 is arranged in the cavity of a spherical coil element 40. The spacing between the coil element 40 and the magnetic element 50 is filled with a liquid 60 in which the magnetic element 50 can freely hover. Thereby, the magnetic element 50 can freely rotate in any direction, relatively to the coil element 40.

FIG. 5 demonstrates an electronic circuit 100 with which the produced voltage can be transformed into direct current, regardless of its polarisation. The voltage produced by coil 110 is transformed by the rectifiers 130 into direct current for the consumer load 120. A capacitor 140 serves for the regulation of the electricity as the electricity of the induction unit fluctuates significantly.

FIG. 6 shows a cutout of an embodiment of the device with an impulse generator (not shown) possessing an axis of rotation 610. The device further has at least one induction unit 600 possessing a magnet 620 and at least one coil 630 and 631. The magnet 620 is connected to an axis 640 which is pivotally connected with the axis of rotation 610 by the wheel 650. Provided the axis of rotation 640 rotates relatively to the induction unit 600 the rotation of the axis of rotation 610 is propagated by the wheel 650 onto axis 640 which can set the magnet 620 pivoted around axis 640 in rotation. Through the rotation of the magnet 620 the magnetic field of the magnet in the coils 630 and 631 changes whereby an alternating current is produced. In this version, the individual magnets are driven by the wheel outside the actual flywheel. In this process, the magnetic axes are running externally on the wheel whereas the magnets themselves are running in the coils inside the flywheel. Due to the larger radius of the flywheel the magnets in the coils are rotating fastly.

In FIG. 7 a different embodiment is represented in which the axis 760 of the discoidal coil element is furnished with a driving disc 750 which can set the driving wheels 780 and 781 of magnets 720 and 721 of the induction unit in rotation. This embodiment has two induction units with each of them comprising a magnet 720 respectively 721 pivoted around an axis 740 or 741 plus coils 730 and 732 respectively 731 and 733. The axes 740 and 741 of the magnets 720 and 721 are each connected pivotally with a wheel 780 and 781 with the driving disc 750 so that a rotation of the axis 760 can be propagated. The coil element 700 in this representation has a weight 770 with which an irregular motion of the device can be more efficiently converted into rotation.

FIG. 8 shows an embodiment with U-shaped bent coils 830 and 831. At this embodiment the device comprises a magnetic element in the form of a circular disc 840 which is pivoted around its centre 860. The disc 840 has the weights 870, 871, and 872 and the magnets 820 and 821. The disc 840 is arranged in parallel and congruent to a second disc 810 and pivotal in respect to this second disc. The second disc 810 has a least one coil 830 and 831 at its periphery. The coils 830 and 831 are bent U-shaped so that a limb of each coil 830 and 831 is arranged on one side and the other limb of each coil 830 and 831 on the other side of disc 840. At the rotation of disc 840 the magnets 820 and 821 rotate through the channel of the coil confined by the limbs of the coils 830 and 831 and thereby producing an alternating current.

FIG. 9 is a cross-sectional view through the embodiment shown in FIG. 8 along the line A-A without disc 810.

In the embodiment represented in FIG. 10 the device has a discoidal impulse generator 840 which is pivoted around its centre 860. The impulse generator 840 comprises at least one weight 870, 871 and 872 plus at least one magnet 1040 and 1041. This embodiment comprises a circular coil element 1010 that comprises at least one coil 1020 and 1021. The circular coil element 1010 is of a circular closed tube design. In the channel of the tube the magnets 1030 and 1031 are contained which are movable along the tube. At a rotation of the impulse generator 840 around the axis 860 the magnets 1040 and 1041 arranged on the impulse generator 840 pull the magnets 1030 and 1031 contained in the tube 1010 due to the magnetic pull caused by the circularly closed tube and through the coils 1020 and 1021 wound in sections around tube 1010. Thereby, an alternating current is produced in the coils.

In a special embodiment the magnets 1020 and 1021 and if applicable further magnets in the coil element 1010 can possess different masses or between each two magnets a non-magnetic weight can be arranged whereupon the different weights, each arranged between two magnets in the ring 1010, can possess different masses. Provided no weights exist between two magnets but the magnets possess different weights, adjacent magnets are arranged in the ring with the poles of the same polarity pointing towards each other so that adjacent magnets repel each other. In these special embodiments the disc 840 can be dispensed the magnets itself act as an impulse generator.

FIG. 11 demonstrates an embodiment which comprises a magnetic element in the form of a circular disc 840 pivoted around its centre 860. The disc 840 has weights 870, 871 and 872 and magnets 820 and 821. At one side of the disc 840 a coil 830 is arranged in whose opening a pivoted magnet is arranged.

FIG. 12 illustrates the design of the configuration of the magnet and coil contained in FIG. 11. The magnet 1220 is arranged in the core area of coil 1220. The magnet 1220 is pivotal around axis 1230 so that the magnet 1220 can produce an alternating current at its rotation in the core area of the coil 1210. For this purpose it is necessary that the magnet 1220 is rotatable in the core area of the coil in terms of the induction law such that a magnetic field can leave and re-enter the coil at a rotation. Provided the magnetic field would stay inside the core area of the coil 1210, no alternating current could be produced. The magnet can be rod-shaped or cuboid. It is also possible to arrange a spherical magnet in the core area of the coil.

In FIG. 13 miscellaneous possibilities are represented how one or several coils 1230, 1231 and 1232 with magnets 1220, 1221 and 1222 contained in their core areas can be arranged in relation to disc 840. The coil can be arranged on top or under the disc 840 or in the plane of disc 840 just outside the periphery of disc 840. It is possible to arrange the coils 1210, 1211 and 1221 in any practical angle related to disc 840.

FIG. 14 shows a cut-out of an embodiment at which the disc 1440 has fins 1450. These fins 1450 can exist instead of magnets on the disc. At a rotation of disc 1440, the fins 1450 produce an air stream perpendicularly to the face of disc 1440. In the direction of the air stream the embodiment has at least one magnet 1420 which is pivotally arranged in the core area of a coil 1410. The axis of rotation 1460 of the magnet 1420 is connected to the impeller 1470 such that the impeller 1470 driven by the air stream can propagate its rotation onto the magnet 1420 which consequently can produce an alternating current in the coil.

Instead of the fins the disc can also be designed as a propeller at which, upon the rotation of the disc, the single blades produce the air stream which rotates the magnet in the coil over a wind-wheel respectively an impeller. Depending on the approach angle of the propeller blades it is possible to direct the air stream towards the coil and the magnet arranged in it as well as directing the air stream from the coil to the propeller. Preferably, it is dealt with a closed flow system at which the air stream cannot evade in any direction or flow around the impeller laterally but is being directed onto the impeller driving the magnet.

FIG. 15 demonstrates a possible embodiment of the impulse generator's weights in the form of a chaotic pendulum. The impulse generator has the weights 870, 871, and 872 with different masses. At least one of the weights 871 and 872 is discoidal and pivoted around an axis 1161 and 1162. Any of the pivoted weights 871 and 872 has two discoidal weight regions of different masses 891 and 893 as well as 892 and 894 which are opposite to each other with regard to the axes 1161 and 1162. Thereby, the total motion of the impulse generator is not predictable because both weights 871 and 872 are freely pivotable around their axes 1161 and 1162.

FIGS. 16A and 16B show different embodiments of the magnetic disc 840 regarding the arrangement of cut-outs for modifiable fixings of weights on the magnetic disc 840. The cut-outs 1610 can be radially arranged so that any weight is shiftable along the cut-out at which it is arranged movable but lockable or fixable. Thereby, the spacing of every single weight to the axis 860 can be adjusted. The rotational speed of the disc can be automatically controlled by the adjustable fixing of the weights in the radially running cut-outs using springs which allow an automatic positioning of the weights along the cut-outs, at which they are fixed adjustable, depending on the rotational speed of disc 840. Alternatively, the magnetic disc can possess multiple cut-outs 1620, 1621 and 1622 arranged as spherical segments with the same spacing to each other for fixation and adjustment of the weights. At this embodiment it is possible, too, to fix a weight by spring elements in their cut-outs.

Thanks to the resulting movability of the weight it can change its position relatively to the other weights on the disc during a rotation so that an effective angular momentum can be produced.

FIG. 17 shows an embodiment with the device 1 comprising at least one discoidal coil element and at least one discoidal magnetic element which are arranged lying parallel to each other and possessing a mutual axis of rotation 840. The axis of rotation 840 is movably connected with the housing wall 1710 so that the axis of rotation can fulfil a precessional motion. By this arrangement a better propagation of the irregular motion of the device into a rotation is accomplished.

FIG. 18 shows a spherical embodiment 1800 of the device comprising an inner sphere 1810, floating respectively hovering in a shell 1820, at which the spacing between the inner sphere 1810 and the shell 1820 is filled with a fluid. The shell 1820 has caverns 1830, 1831 and 1832, thus almost spherical protuberances. In the caverns, spherical magnets 1840 are arranged. In this embodiment the inner sphere 1810 propagates its rotation by the viscosity of the fluid 1850 enclosing the sphere 1810 and the spherical magnets 1840 onto the spherical magnets. The inner sphere 1810 has at least two weights 1870 and 1872 with different masses in order to accelerate the inner sphere 1810 and to transform the irregular motion of the device in a rotational motion of the inner sphere 1810. The inner sphere 1810 can exist as hollow sphere filled with a fluid. The inner sphere 1810 as a hollow sphere can possess blades, collars or notches at its inner face or its outer face in order to be able to move the fluid in the narrow spacing between the inner sphere 1810 and the shell 1820 so that the motion can be better propagated to the spherical magnets 1840.

The cavity enclosed by the shell 1820 and the cavities 1830, 1831 and 1832 enclosed by the protuberances are in direct connection to each other. That means that the peripheries are intersecting each other. The cavities of the caverns 1830, 1831 and 1832 and the shell 1820 are not connected to each other by ducts. Any of the protuberances has at least one coil at its outer face. By rotation of the magnetic sphere 1840 in any direction an alternating current can be produced in the coil.

Alternatively to the embodiment represented in FIG. 18, the device can possess an inner sphere with shell which is not furnished with caverns. The cavities formed by the caverns can be designed in the form of separate cavities which are arranged around the shell of the inner sphere. Here the inner sphere has magnets on or at its surface which can interact with the spherical magnets contained in the cavities of the shell-enclosing hollow spheres such that they can induce a rotation of the spherical magnets if they are passed over at them.

The shell with the protuberances can be arranged in a hollow sphere 1910, resulting in a layered structure as represented in FIG. 19.

FIG. 20 shows an embodiment at which the inner sphere 2010 is furnished with magnets 2020 and 2021 or also with ferromagnetic metal bands. This embodiment has three rings 1010, 1011 and 1012 standing perpendicularly to each other which enclose the inner sphere 2020. The rings 1010, 1011 and 1012 are ring-shaped coil elements with each of them comprising at least one coil 1020 and 2021. Any ring-shaped coil element 1010, 1011, and 1012 is designed in the form of a closed ring-shaped tube. Magnets 1020 and 1021 are contained in the duct of the tube which are movable alongside the tube. At a rotation of the magnetic element 2010 the magnetic elements 2020 and 2021 arranged on the magnetic element 2010 are pulling the magnets 1020 and 2021 contained in the tube 1010, 1011, and 1012 through the closed ring-shaped tube and through the coils 830 and 831 wound in sections around the tube 1010, 1011, and 1012 due to the magnetic pull. This produces an alternating current in the coils.

In a different embodiment one ring or multiple rings can be gimballed so that itself and the magnets can adjust to the rotation of the large inner sphere. Here it is also possible to connect multiple rings with each other, for example by lying on one another or standing in an angle of 90° to each other.

Also in a spherical embodiment, the shell can have several coils with magnets pivoted in the core areas of its coils as shown in FIG. 21. Preferably, in each case the adjacent coils and directions of rotation of the magnets contained in it are twisted by 90°—or in any other practical angle—to each other as shown in FIG. 22 which enlarges the cut-out 2100 and shows it in top view. FIG. 22 shows an arrangement of 3×3 coils at which the adjacent coils and the axes of rotation in their core areas are respectively twisted to each other by 90°. By this, the rotational motions of the inner sphere 2010 in any direction can be used to generate electricity. The inner sphere 2010 has magnets 2120, 2121 and 2122 at its surface which can set the magnets 1220 and 1221, pivoted in the core areas of the coils, in rotation due to the magnetic pull if a magnet 2120, 2121 and 2122 of the inner sphere passes by at the according coil 1230 and 1231. This embodiment also has the advantage that the torque of the large inner sphere is only little affected by the magnetic interaction and the little magnets in the openings of the coils can rotate significantly faster.

The embodiment represented in FIG. 22 can be modified in such a way that spherical magnets instead of rod-shaped or ashlar-formed magnets 1220 and 1221 can be pivoted in the coils 1230 and 1231.

FIG. 23A shows an embodiment at which the magnetic coupling is also used between the magnets or the ferromagnetic metal bands of the impulse generator and the magnets of the induction unit. In the represented embodiment the sphere 2010 is contained freely pivotal in the cavity 1850 of a shell 1820. The spacing between shell 1820 and sphere 2010 is filled with a liquid 1851 in which the sphere 2010 hovers. The sphere 2010 has one or several magnets 2020 and 2021 or ferromagnetic metal bands at its surface. Shell 8020 is enclosed with one or multiple components of a coil element 2300. Any component has a holding device 2310 and 2311 a magnet 2320 and 2321 and a coil 2330 and 2331. The coil 2330, 2331 encloses the holding device 2310 and 2311. Any magnet 2320 and 2321 is held by springs 2340, 2342, 2341 and 2343 in its holding device 2310 and 2311, whereupon the springs extend from the magnet's poles to the end of the holding device turned towards its respective pole. In this way any magnet in its holding device can fulfil a translational pendulum motion essentially in only one dimension. The holding device is arranged so that the magnet, held by it, is arranged in the core area of the coil.

At a rotation of the sphere 2010 the magnets 2020 and 2021 or ferromagnetic metal bands are passed by the induction units 2300. Due to the magnetic pull the magnets 2320 and 2321 are set into a translational motion in their holding devices 2310 and 2311 and are put back in the starting position by their spring elements. In addition, the magnet can post-pulse oscillate and generate an alternating current in this process. By this translational pendulum motion the magnetic field in the coil changes and an alternating current can be produced.

A possible alternative holding device for a magnet, which is to fulfil a translational pendulum motion in the core area of a coil, could be the variant of the component of a coil element 2301 represented in FIG. 23B. This component 2301 has a holding device 2312 at whose opposite ends each a magnet 2350 and 2351 is unmovably fixed. One holding magnet 2350 points with its south pole into the holding device whereas the opposite magnet 2351 points its north pole into the holding device. The induction magnet 2322 is arranged in the holding device so that it points with its south pole to the south pole of the holding magnets 2350 and with its north pole to the north pole of the holding magnet 2351. Due to the magnetic repulsive forces the induction magnet 2322 is held levitating in the holding device 2312 and can be deflected by the influence of an outer magnetic field (not shown) out of its resting position in the direction of one and/or the other holding magnets which put the induction magnet back in its resting position and/or allow the spring-like post-pulse oscillation but also deceleration. So a translational pendulum motion essentially running in one dimension results for the induction magnet 2322 which can induce an alternating current in the coil (not shown) enclosing the induction magnet.

The individual coils with a pivoted magnet—spherical magnet, bar magnet, or ashlar-formed magnet—in their core areas can also exist encapsulated in single shells. This allows the capsule to be filled with a liquid, so that in particular spherical magnets can be held freely rotatable in any direction in the centre of the core areas and not touching the coil as the spheres itself are encapsulated and the coils are lying around this capsule.

The embodiments with separate pivotal magnets pivotally set in rotation in the coil's core areas by magnets or ferromagnetic metal bands have the benefit that a significantly faster rotation of the magnets in the coils can be achieved in relation to the rotational speed of the impulse generator if a relatively large impulse generator and small coils are used. By this, an efficient electricity generation even at relatively small or slow total motion of the device is possible.

The current collection is not imperatively required in a way that the magnetic field of a magnet is changed directly in the coil. By means of a ferroelectric core it is possible to route the changing of the magnetic field of a magnet to a coil. FIG. 24A demonstrates such an embodiment at which the device has a disc 2440 pivotal around an axis 2460. The disc 2440 has multiple magnets 2420 whose axis can be arranged perpendicularly to the plane of the disc 2440 and in alternating orientation. FIG. 24B shows such a disc in top view. This embodiment of the device furthermore has a ring-shaped not closed core 2450 of a ferroelectric material which is enclosed in an area of a coil 2430. Of course, a core 2450 can be furnished with several coils as well. Likewise, the magnets 2420 can also operate several of the C-shaped or differently shaped magnetic elements (for example E-shaped) preferably at the embodiments with a spherical impulse generator.

In the embodiment represented in FIG. 24A the magnets are led through the opening in the core 2450 by a rotational motion of the disc 2440 around axis 2460. The changing of the magnetic field in this sector leads to the induction of an alternating current in the coil 2430. Alternatively to that, as represented in FIG. 24C, a magnet 2470 can be pivoted around axis 2430 in the opening of the core 2450. Here the magnets 2420 arranged on the disc 2440 lead to a rotational motion of the magnet 2470 around the axis 2480 so that an alternating current is generated by the magnetic field changing in the area of the opening of the core. This embodiment can also be realized with small spherical coils at spherical embodiments of the impulse generator.

1. Device for the generation of electricity from irregular motion comprising at least one generator, which at least one generator comprises at least one impulse generator having an axis of rotation and at least one induction unit, the induction unit comprising at least one coil element and at least one magnetic element and the at least one magnetic element is freely pivoted in respect to the at least one coil element, wherein the impulse generator comprises at least two weights which possess different masses and/or different spacing to the axis of rotation of the impulse generator and produce different torques.

2. Device according to claim 1 wherein the coil element and/or the magnetic element is discoidal, wheel-shaped, ring-shaped or spherical.

3. Device according to claim 1, wherein the impulse generator comprises at least three weights which possess different masses and/or different spacing to the axis of rotation of the impulse unit and produce different torques.

4. Device according to claim 1, wherein the coil and magnetic elements are discoidal, the weights of the impulse generator at the discoidal coil and magnetic elements are movably arranged at rods radially connected to the axis at which any weight is connected to a roll by a separate thread or wire which is pivotable independently from the rotation of the axis and lockable on the axis, and any rod is enclosed by a scroll spring which is arranged between axis and weight.

5. Device according to claim 1, wherein at least one of the weights of the impulse generator is held by a spring which spring adjusts the space of the weight to the axis of rotation such that a predefined velocity of the impulse generator is not exceeded.

6. Device according to claim 1, comprising two of the impulse generators arranged such that their discoidal coil elements and magnetic elements are perpendicular to each other.

7. Device according to claim 1, comprising three of the impulse generators arranged such that their discoidal coil elements and magnetic elements are perpendicular to each other or represent the legs of a triangle.

8. Device according to claim 1, wherein the coil elements are firmly arranged in the device.

9. Device according to claim 1, wherein the magnetic elements are firmly arranged in the device.

10. Device according to claim 1, wherein the at least one coil element and the at least one magnetic element are each spherical, each of the coil elements is hollow and has a respective one of the magnetic elements received therein.

11. Device according to claim 10, wherein space between each of the coil elements and the magnetic element received therein is filled with a liquid in which the magnetic element is suspended.

12. Device according to claim 1, wherein the weights are configured as a chaotic pendulum.

13. Device according to claim 1, wherein at least one of the magnetic elements is discoidal or spherical and has at least one magnet and at least one of the coil elements is shaped as a closed ring-shaped tube in which at least one magnet is movably disposed.

14. Device according to claim 1, wherein at least one coil has a core area at which a pivoted magnet is arranged whereby the pivoted magnet can be set in motion by at least one of the magnets of the impulse generator.

15. Method of generating electrical energy, comprising operating the device according to claim 1.

16. Device according to claim 3, wherein the impulse generator comprises at least four of the weights.
